(19) United States
(12) Patent Application Publication
(10) Pub. No.: US 2006/0065729 A1
(43) Pub. Date: Mar. 30, 2006

(54) Card connection device and information processing apparatus equipped with the card connection device

(75) Inventor: Tatsuya Miyairi, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/236,552

(22) Filed: Sep. 28, 2005

(30) Foreign Application Priority Data
Sep. 30, 2004 (JP) 2004-287494

(51) Int. Cl. G06K 7/06

(52) U.S. Cl. 235/441

(57) ABSTRACT

A card connection device includes a device body having a mount portion, a slot, and a stopper. The mount portion has a plurality of regions into which a plurality of card-shaped storage media can be detachably attached. The plurality of regions is laminated on one another in a direction of thickness of the car-shaped recording media. The slot has a substantial opening shape corresponding to the plurality of regions to insert the card-shaped storage media into the regions respectively. The stopper is displaced in the direction of the card-shaped storage medium by a contact with the one card-shaped storage medium to prevent the other card-shaped storage medium from being inserted into remaining regions, when one of the card-shaped storage medium is inserted into corresponding one of the plurality of regions through the slot.

### CROSS REFERENCE TO RELATED APPLICATION

This application is based upon and claims the benefit of priority from the prior Japanese patent Application NO. 2004-287494, filed on Sep. 30, 2004; the entire contents of which are incorporated herein by reference.

### BACKGROUND

1. Field

The present invention relates to a card connection device into which one recording medium selected from a plurality of card-shaped storage media such as an SD memory card and a Smart Media® card can be detachably attached, and an information processing apparatus such as a portable computer equipped with the card connection device.

2. Description of the Related Art

Small-size memory cards provided with flash memories, such as an SD memory card, a Smart Media® card and a Memory Stick® card are widely used as media for recording image data, for example, picked up by a digital camera. Because these types of memory cards are different in form in accordance with their standards, an information processing apparatus into which these memory cards can be attached need be equipped with exclusive card slots having sizes conformable to the standards respectively.

According to this configuration, it is however necessary to provide a plurality of card slots in the information processing apparatus so that a plurality of memory cards conformable to different standards can be mounted. For this reason, there is a demerit that reduction in thickness and size of the information processing apparatus is obstructed to thereby cause increase in cost.

In order to solve this demerit, there has been recently an attempt to design a card connection device having one card slot into which a plurality of memory cards conformable to different standards can be attached so that reading/writing of data can be executed. This card connection device includes a cartridge inserted into one slot of the information processing apparatus, a first card slot into which a memory card conformable to the SD memory card standard can be inserted, and a second card slot into which another memory card conformable to another standard can be inserted.

A plurality of memory cards can be supported by one slot of the information processing apparatus, so that data exchange can be performed easily between the information processing apparatus and the plurality of memory cards conformable to different standards (see Japanese Utility Model Registration No. 3100182).

### BRIEF SUMMARY

According to the card connection device described in Japanese Utility Model Registration No. 3100182, a plurality of memory cards conformable to different standards may be supported simultaneously by the information processing apparatus because memory cards can be inserted into the first and second card slots respectively. Therefore, the information processing apparatus must have a controller capable of performing reading/writing of data from/into the plurality of memory cards simultaneously when the plurality of memory cards are supported simultaneously.

The product cost of the controller capable of performing reading/writing of data from/into the plurality of memory cards simultaneously is however so high that there is a disadvantage in terms of cost. In addition, the operation of the controller may become unstable in accordance with the combination of memory cards used for simultaneous execution of reading/writing of data. There is another demerit that reliability on reading/writing of data is lowered.

An object of the invention is to provide a card connection device which is formed so that a plurality of card-shaped storage media can be prevented from being mounted simultaneously in the case where the plurality of card-shaped storage media can be supported by one slot.

Another object of the invention is to provide an information processing apparatus which is formed so that a plurality of card-shaped storage media can be prevented from being mounted simultaneously so that reliability on execution of reading/writing of data can be improved while an expensive controller capable of executing reading/writing of data from/into the plurality of card-shaped storage media simultaneously can be dispensed with.

### BRIEF DESCRIPTION OF THE DRAWINGS

FIG. 1 is a perspective view of a portable computer according to an embodiment of the invention.

FIG. 2 is a perspective view showing a card connection device and shapes of card-shaped storage media allowed to be attached into the card connection device.

FIG. 3 is a perspective view of the card connection device, showing the shape of an opening of a slot.

FIG. 4 is a perspective view of the card connection device, showing the shape of a mount portion connected to the slot.

FIG. 5 is a front view of the card connection device, showing the positional relation between the slot and a Smart Media® card in the condition that the Smart Media® card has been attached into a first region of the mount portion.

FIG. 6 is a front view of the card connection device, showing the positional relation between the slot and an SD memory card in the condition that the SD memory card has been attached into a second region of the mount portion.

FIG. 7 is a front view of the card connection device, showing the positional relation between the slot and an xD picture card in the condition that the xD picture card has been attached into a third region of the mount portion.

FIG. 8 is a plan view showing a state in which the card connection device has been put in the inside of the portable computer.

FIG. 9 is a perspective view of a stopper.

FIG. 10 is a sectional view showing a state in which the stopper has been attached into a device body.

FIG. 11 is a front view of the card connection device, showing the positional relation between the slot and the stopper retained in a neutral position.

FIG. 12 is a front view of the card connection device, showing the positional relation between the stopper and the slot in the condition that the Smart Media® card has been attached into the first region of the mount portion.

FIG. 13 is a side view showing the positional relation between a front end of the Smart media® card and a first cam face of the stopper.

FIG. 14 is a front view of the card connection device, showing the positional relation between the stopper and the slot in the condition that the SD memory card has been attached into the second region of the mount portion.

FIG. 15 is a side view showing the positional relation between a front end of the SD memory card and a second cam face of the stopper.

FIG. 16 is a front view of the card connection device, showing the positional relation between the stopper and the slot in the condition that the xD picture card has been attached into the third region of the mount portion.

FIG. 17 is a side view showing the positional relation between a front end of the xD picture card and a third cam face of the stopper.

### DETAILED DESCRIPTION

An embodiment of the invention will be described below with reference to the drawings concerned with a portable computer.

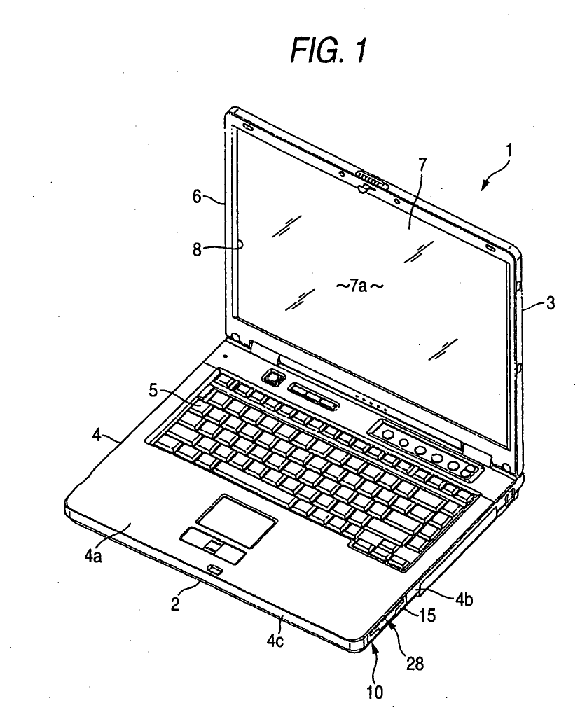

FIG. 1 shows a portable computer 1 which is an example of an information processing apparatus. The portable computer 1 includes a computer body 2, and a display unit 3 supported by the computer body 2. The computer body 2 has a housing 4. The housing 4 is shaped like a flat box which has an upper wall 4a, left and right side walls 4b, a front wall 4c, and a bottom wall (not shown). The upper wall 4a of the housing 4 supports a keyboard 5.

The display unit 3 has a display housing 6, and a liquid crystal panel 7 received in the display housing 6. The display housing 6 is connected to a rear end portion of the housing 4 by hinges not shown, so that the display housing 6 can rotate between a close position and an open position. The liquid crystal panel 7 has a display screen 7a. The display screen 7a is exposed to the outside of the display housing 6 through an opening portion 8 formed in a front surface of the display housing 6.

As shown FIG. 1, the housing 4 of the portable computer 1 receives a card connection device 10. For example, the card connection device 10 is designed so that one card-shaped storage medium selected from five kinds of card-shaped storage media such as a Smart Media® card 11, an SD memory card 12, a Memory Stick® card 13, an xD picture card 14 and an MMC card not shown, can be detachably attached into the card connection device 10.

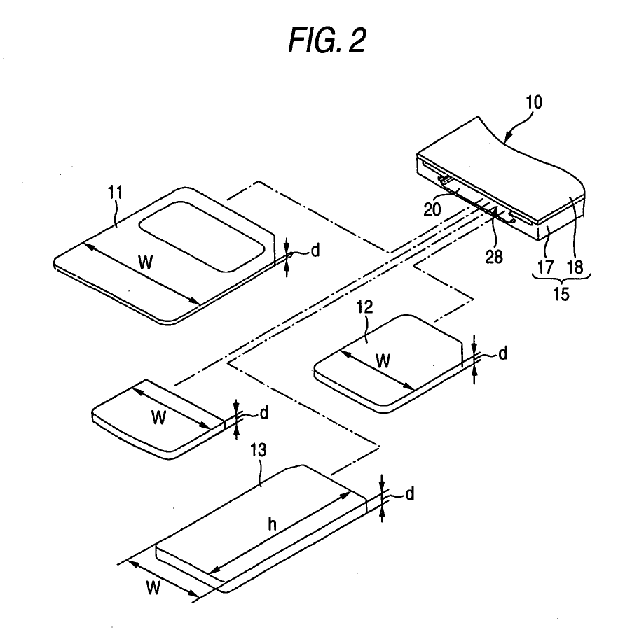

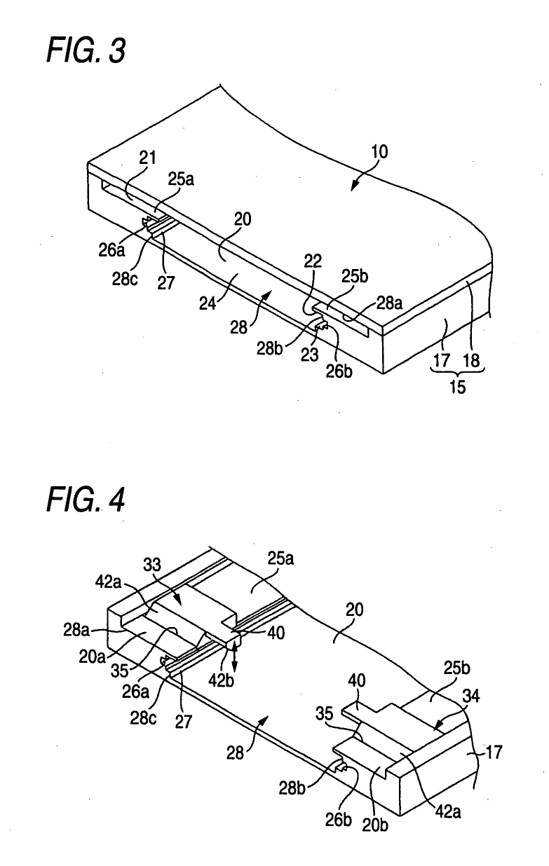

When sizes of the five kinds of card-shaped storage media are compared with one another, the thickness (d) of the Smart Media® card 11 is the smallest of them but the width (w) of the Smart Media® card 11 is the largest of them as shown in FIG. 2. The SD memory card 12 and the MMC card conform to the SMDI standards. The thickness (d) of each of the SD memory card 12 and the MMC card is larger than the thickness (d) of the Smart Media® card 11 but the width (w) of each of the SD memory card 12 and the MMC card is smaller than the width (w) of the SmartMedia® card 11. The thickness (d) and length (h) of the Memory Stick® card 13 are larger than those of the SD memory card 12 but the width (w) of the Memory Stick® card 13 is smaller than that of the SD memory card 12. The width (w) of the xD picture card 14 is substantially equal to that of the SD memory card 12 but the thickness (d) of the xD picture card 14 is larger than that of the SD memory card 12.

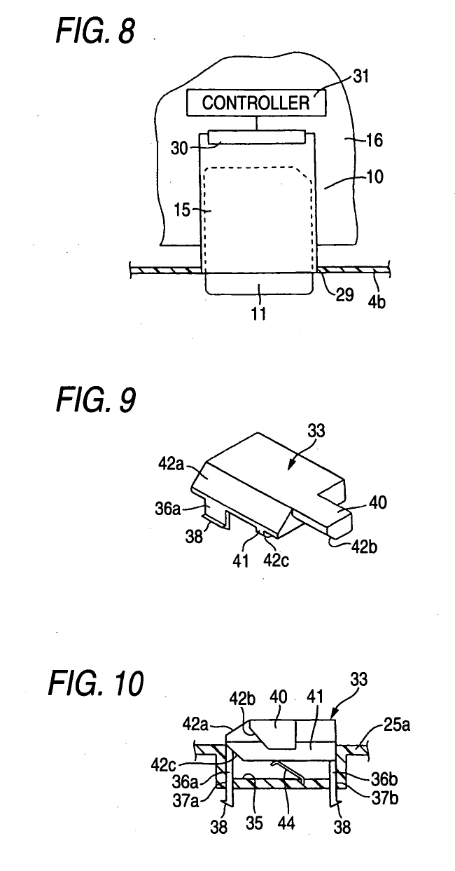

The card connection device 10 into which the five kinds of card-shaped storage media can be attached has a device body 15 made of synthetic resin. The device body 15 is shaped like a flat box and mounted on an upper surface of a printed circuit board 16 (shown in FIG. 8) received in the housing 4.

The device body 15 has a base 17, and a top cover (top plate) 18 put on the base 17. A mount portion 20 into which the five kinds of card-shaped storage media can be mounted is formed in the inside of the base 17. The mount portion 20 has a first region 21 corresponding to the Smart Media® card 11, a second region 22 corresponding to the SD memory card 12 and the MMC card, a third region 23 corresponding to the xD picture card 14, and a fourth region 24 corresponding to the Memory Stick® card 13.

The first to fourth regions 21 to 24 are laminated on one another along the direction of thickness of the card-shaped storage media, that is, along the direction of thickness of the housing 4. The first region 21 is formed between an upper surface of the base 17 and the top plate 18 and located in the topmost position of the mount portion 20. The first region 21 is wide enough to cover the whole width of the device body 15.

The second region 22 is disposed below the first region 21 and formed to be narrower in width than the first region 21. To this end, the mount portion 20 has a pair of partition walls 25a and 25b which wedge in between the first region 21 and the second region 22. These partition walls 25a and 25b are located at one end and the other end, respectively, along the width direction of the first and second regions 21 and 22. The Smart Media® card 11 to be mounted into the first region 21 can be placed on the partition walls 25a and 25b.

The third region 23 is located in a position shifted downward from the second region 22 and is formed to be wider in width than the second region 22. Further, the second region 22 and the third region 23 are arranged to overlap each other in the thickness direction of the SD memory card 12 and the xD picture card 14. To this end, the third region 23 is formed so that the third region 23 except its bottom and its one end and the other end along the width direction can be used in common with the second region 22. As a result, the mount portion 20 has: guide grooves 26a and 26b which are formed in positions corresponding to the third region 23 so that one end and the other end of the xD picture card 14 along the width direction can enter the guide grooves 26a and 26b respectively; and a recess 27 formed to avoid a lower surface of the xD picture card 14.

The fourth region 24 completely overlaps the second and third regions 22 and 23, so that the fourth region 24 is located between the recess 27 of the mount portion 20 and the partition walls 25a and 25b.

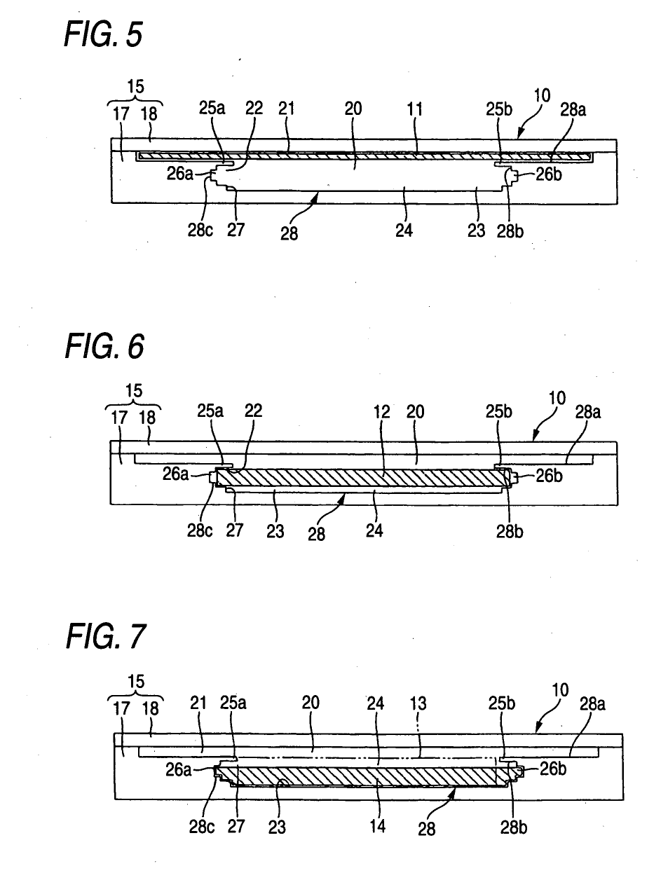

As shown in FIGS. 5 through 7, the device body 15 has a slot 28. The slot 28 is provided so that the five kinds of card-shaped storage media can be inserted into the first to fourth regions 21 to 24 corresponding to the five kinds of card-shaped storage media, respectively. The slot 28 has first to third opening portions 28a to 28c corresponding to the first to third regions 21 to 23. The first to third opening portions 28a to 28c are different from one another in terms of width and thickness. The first to third opening portions 28a to 28c are formed as such an opening that the regions 21 to 23 are enclosed continuously by the opening while the first to third opening portions 28a to 28c communicate with one another along the direction of lamination of the first to third regions 21 to 23.

The slot 28 is formed in one end surface of the device body 15. The one end surface of the device body 15 inclusive of the slot 28 is exposed to the outside of the portable computer 1 through a cut-out 29 formed in the side wall 4b.

The device body 15 has connection terminals (not shown) electrically connected to the five kinds of card-shaped storage media. The connection terminals are electrically connected to a controller 31 (shown in FIG. 8) through an interface connector 30. The controller 31 is provided for executing reading/writing of data from/into the five kinds of card-shaped storage media individually. The controller 31 is mounted in the printed circuit board 16 inside the housing 4.

As shown in FIG. 4, the mount portion 20 of the card connection device 10 has a first end portion 20a and a second end portion 20b separate from each other in the width direction of the card-shaped storage media. Stoppers 33 and 34 are provided in the first and second end portions 20a and 20b respectively. The stoppers 33 and 34 are provided so that when one of the five kinds of card-shaped storage media is mounted in the mount portion 20, the other four kinds of card-shaped storage media can be prevented from being mounted simultaneously in the mount portion 20. Since the stoppers 33 and 34 have one and the same configuration, one 33 of the stoppers will be described representatively.

As shown in FIGS. 4 and 10, the stopper 33 is disposed in a recess 35 provided in the partition wall 25a. The recess 35 is located just behind the slot 28 and opened to the first to fourth regions 21 to 24. The stopper 33 is shaped like as a flat plate and has a pair of guide legs 36a and 36b which protrude downward from a lower surface of the stopper 33. The guide legs 36a and 36b are disposed at a distance from each other so as to be parallel to each other. A pair of guide holes 37a and 37b are formed in the bottom of the recess 35. The guide legs 36a and 36b slidably pass through the guide holes 37a and 37b respectively. Engagement claws 38 are formed at front ends of the guide legs 36a and 36b, respectively. The engagement claws 38 are provided so as to be caught in a lower surface of the recess 35.

Therefore, the stopper 33 is supported by the partition wall 25a so that the stopper 33 can move up and down along the thickness direction of the card-shaped storage media while guided by the guide legs 36a and 36b.

The stopper 33 has an extension portion 40 which protrudes toward a center portion along the width direction of the first region 21. The extension portion 40 is located above the second and fourth regions 22 and 24 and has a front end which faces the slot 28. Further, a salient 41 is formed on the lower surface of the stopper 33. The salient 41 protrudes from the lower surface of the stopper 33 toward the guide groove 26a of the third region 23.

As shown in FIGS. 9 and 10, the stopper 33 has first to third cam faces 42a to 42c. The first cam face 42a is located at a corner portion provided by the upper and front surfaces of the stopper 33. The first cam face 42a is inclined downward as going toward the slot 28. The first cam face 42a is located in the first region 21.

The second cam face 42b is located at a corner portion provided by the front and lower surfaces of the extension portion 40. The second cam face 42b is inclined downward as going away from the slot 28. The direction of inclination of the second cam face 42b is opposite to that of the first cam face 42a. The second cam face 42b is located above the second and fourth regions 22 and 24.

The third cam face 42c is located at a corner portion provided by the front and lower surfaces of the salient 41. The third cam face 42c is inclined downward as going away from the slot 28. The direction of inclination of the third cam face 42c is opposite to that of the first cam face 42a. The third cam face 42c is located below the first and second cam faces 42a and 42b and at one side portion of the third region 23.

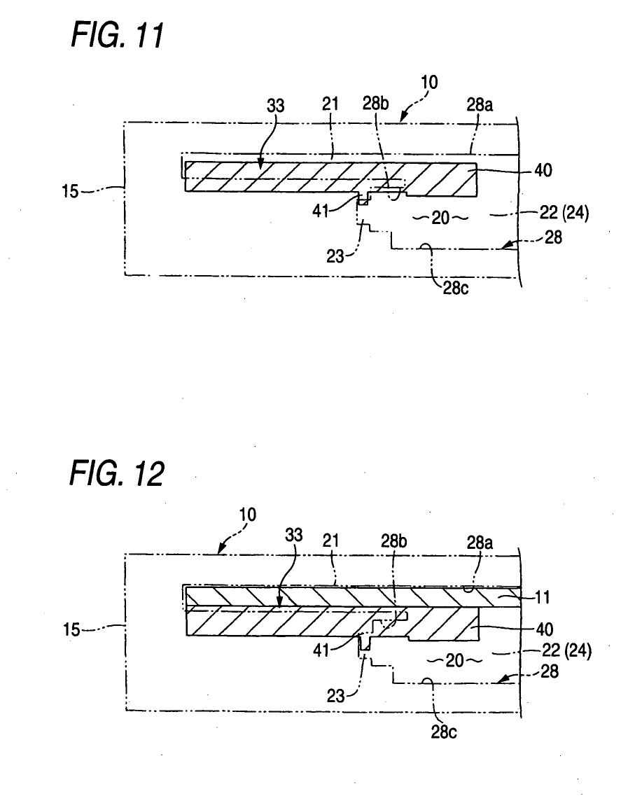

As shown in FIG. 10, a plate spring 44 is interposed between the stopper 33 and the bottom of the recess 35. The plate spring 44 pushes the stopper 33 up from the bottom of the recess 35, so that the stopper 33 is retained in a neutral position shown in FIG. 11. In the neutral position, the stopper 33 is located in an intermediate portion along the height direction of the mount portion 20. Therefore, the first to third cam faces 42a to 42c face the slot 28 while exposed to the first to fourth regions 21 to 24 respectively.

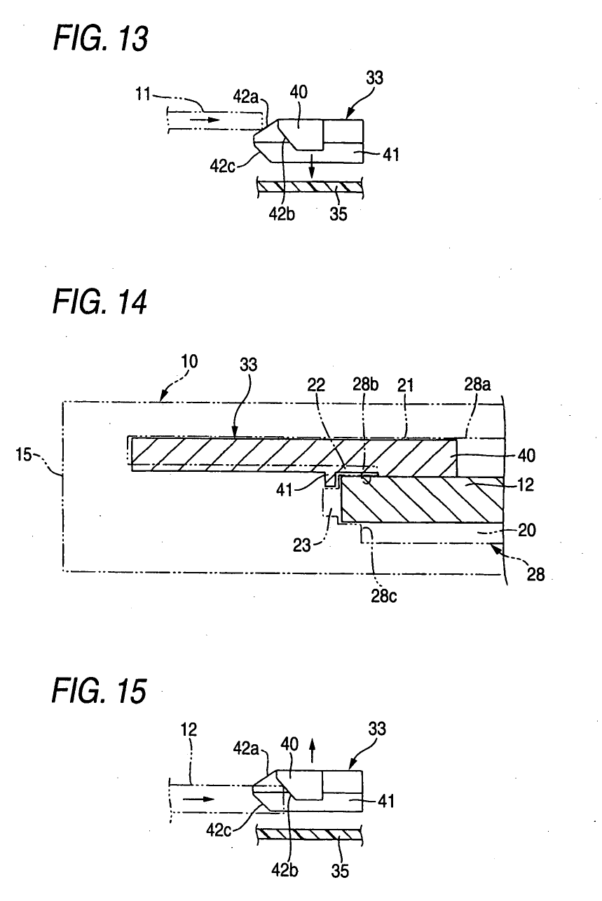

FIGS. 12 and 13 show a state in which the Smart Media® card 11 is attached into the first region 21 of the mount portion 20. The Smart Media® card 11 is inserted from the first opening portion 28a of the slot 28 into the first region 21 which is provided at the upper end of the mount portion 20. The stopper 33 located just behind the slot 28 is retained in the neutral position as long as the mount portion 20 is empty. On this occasion, the first cam face 42a of the stopper 33 is exposed to the first region 21.

Accordingly, when the Smart Media® card 11 is inserted into the first region 21 through the slot 28, a front edge of the Smart Media® card 11 abuts on the first cam face 42a of the stopper 33 as represented by the broken line in FIG. 13. Because the first cam face 42a is inclined downward as going toward the slot 28, downward force acts on the stopper 33 at the point of time when the Smart Media® card 11 abuts on the first cam face 42a. Accordingly, the stopper 33 is pushed down against the urging force of the plate spring 44, so that the Smart Media® card 11 is led into the first region 21.

Consequently, as shown in FIG. 12, the salient 41 of the stopper 33 overhangs the third region 23 while the extension portion 40 of the stopper 33 overhangs the second region 22 and the fourth region 24.

Accordingly, when, for example, the SD memory card 12 is intended to be inserted into the second region 22 in the condition that the Smart Media® card 11 has been inserted into the first region 21, a front edge of the SD memory card 12 collides with the front end of the extension portion 40 of the stopper 33. Similarly, when the Memory Stick® card 13 is intended to be inserted into the fourth region 24, a front edge of the Memory Stick® card 13 collides with the front end of the extension portion 40. In this manner, the extension portion 40 of the stopper 33 prevents the SD memory card 12 and the Memory Stick® card 13 from being inserted.

When the xD picture card 14 is intended to be inserted into the third region 23 in the aforementioned condition, a front edge of the xD picture card 14 collides with the salient 41. In this manner, the salient 41 of the stopper 33 prevents the xD picture card 14 from being inserted.

Accordingly, as long as the Smart Media® card 11 has been attached into the first region 21, the other card-shaped storage media such as the SD memory card 12 are disabled from being inserted into the remaining second to fourth regions 22 to 24.

FIGS. 14 and 15 show a state in which the SD memory card 12 or the MMC card is inserted into the second region 22 of the mount portion 20. The SD memory card 12 or the MMC card is inserted from the second opening portion 28b of the slot 28 into the second region 22 of the mount portion 20. The stopper 33 located just behind the slot 28 is retained in the neutral position as long as the mount portion 20 is empty. On this occasion, the second cam face 42b of the stopper 33 is exposed to the second region 22.

Thus, when the SD memory card 12 or the MMC card is inserted into the second region 22 through the slot 28, the front edge of the SD memory card 12 or the MMC card abuts on the second cam face 42b as represented by the broken line in FIG. 15. Because the second cam face 42b is inclined downward as going away; from the slot 28, upward force acts on the stopper 33 at the point of time when the front edge of the SD memory card 12 or the MMC card abuts on the second cam face 42b. Accordingly, the stopper 33 is pushed up to be higher than the neutral position, so that the upper portion of the stopper 33 and the extension portion 40 overhang the first region 21 largely while the SD memory card 12 or the MMC card is led into the second region 22.

Accordingly, when, for example, the Smart Media® card 11 is intended to be inserted into the first region 21 in the condition that the SD memory card 12 or the MMC card has been attached into the second region 22, the front edge of the Smart Media® card 11 collides with the stopper 33 and the extension portion 40. In addition, the second region 22 overlaps the third and fourth regions 23 and 24 so that at least one part of the second region 22 is used in common with the third and fourth regions 23 and 24. Accordingly, as long as the SD memory card 12 or the MMC card has been attached into the second region 22, the SD memory card 12 or the MMC card becomes an obstacle to insertion of the xD picture card 14 and the Memory Stick® card 13 into the third and fourth regions 23 and 24.

In this manner, in the condition that the SD memory card 12 or the MMC card has been attached into the second region 22, the other card-shaped storage media such as the xD picture card 14 are disabled from being inserted into the remaining regions 21, 23 and 24.

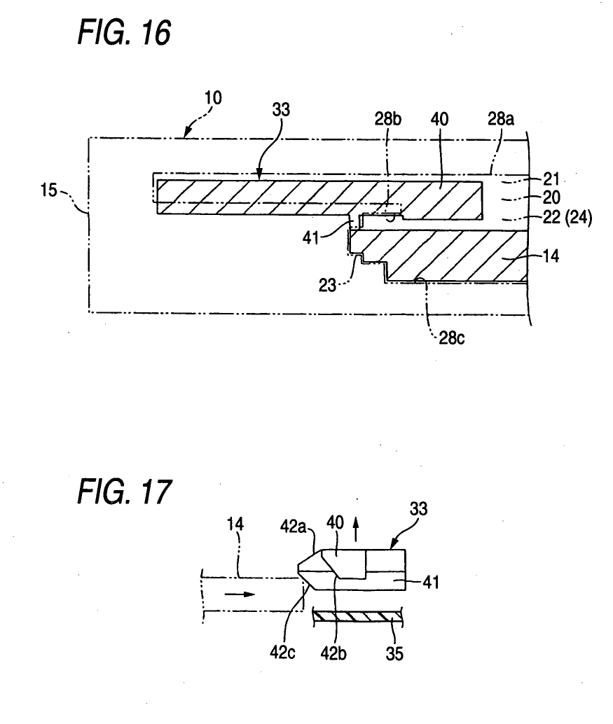

FIGS. 16 and 17 show a state in which the xD picture card 14 is inserted into the third region 23 of the mount portion 20. The xD picture card 14 is inserted from the third opening portion 28c of the slot 28 into the third region 23 of the mount portion 20. The stopper 33 located just behind the slot 28 is retained in the neutral position as long as the mount portion 20 is empty. On this occasion, the third cam face 42c of the stopper 33 is exposed to the third region 23.

Thus, when the xD picture card 14 is inserted into the third region 23 through the slot 28, the front edge of the xD picture card 14 abuts on the third cam face 42c of the stopper 33 as represented by the broken line in FIG. 17. Because the third cam face 42c is inclined downward as going away from the slot 28, upward force acts on the stopper 33 at the point of time when the front edge of the xD picture card 14 abuts on the third cam face 42c. Accordingly, the stopper 33 is pushed up to be higher than the neutral position, so that the upper portion of the stopper 33 and the extension portion 40 overhang the first region 21 largely while the xD picture card 14 is led into the third region 23.

Accordingly, when, for example, the Smart Media® card 11 is intended to be inserted into the first region 21 in the condition that the xD picture card 14 has been attached into the third region 23, the front edge of the Smart Media® card 11 collides with the stopper 33 and the extension portion 40. In addition, the third region 23 overlaps the second and fourth regions 22 and 24 so that at least one part of the third region 23 is used in common with the second and fourth regions 22 and 24. Accordingly, as long as the xD picture card 14 has been attached into the third region 23, the xD picture card 14 becomes an obstacle to insertion of the other card-shaped storage media such as the SD memory card 12 into the second and fourth regions 22 and 24.

Accordingly, in the condition that the xD picture card 14 has been attached into the third region 23, the other card-shaped storage media such as the Memory Stick® card 13 are disabled from being inserted into the remaining regions 21, 22 and 24.

On the other hand, when the Memory Stick® card 13 is inserted into the fourth region 24, the front edge of the Memory Stick® card 13 comes into contact with the second cam face 42b of the stopper 33 in the same manner as in the case where the SD memory card 12 is attached is pushed up to be higher than the neutral position, so that the Smart Media® card is prevented from being inserted into the first region 21. In addition, as long as the Memory Stick® card 13 has been attached into the fourth region 24, the Memory Stick® card 13 becomes an obstacle to insertion of the other card-shaped storage media such as the SD memory card 12 into the second and third regions 22 and 23.

According to the aforementioned configuration, when one medium selected from the five kinds of card-shaped storage media is attached into any one of the first to fourth regions 21 to 24 of the mount portion 20, the stoppers 33 and 34 are displaced vertically in accordance with the shapes of the first to third cam faces 42a to 42c. As a result, the other kinds of card-shaped storage media are disabled from being inserted into the remaining regions 21 to 24.

In this manner, two kinds of card-shaped storage media can be prevented from being attached into the mount portion 20 simultaneously, so that an expensive controller which makes it possible to read/write data simultaneously from/into a plurality of card-shaped storage media can be dispensed with at the time of execution of reading/writing of data between each of the card-shaped storage media and the controller 31.

In other words, when one selected from the five kinds of card-shaped storage media is attached into one mount portion 20, reading/writing of data from/into the card-shaped storage medium can be made stably though the controller 31 cannot choose but perform reading/writing of data from/into one card-shaped storage medium.

Accordingly, there is a merit that not only can the cost of the card connection device 10 be reduced but reliability on reading/writing of data from/into the card-shaped storage medium can be also improved.

According to the aforementioned embodiment, the second to fourth regions 22 to 24 of the mount portion 20 overlap one another so that at least parts of these regions are used in common. Thus, the thickness of the mount portion 20 can be reduced so that the card connection device 10 can be formed so as to be thin and compact sufficiently to be incorporated in the inside of the housing 4 of the portable computer 1 reasonably.

Although the embodiment has been described on the case where the card connection device into which five kinds of card-shaped storage media can be attached is taken as an example, the embodiment of the invention is not limited thereto. For example, the embodiment of the invention can be also applied to a card connection device including a mount portion into which two kinds of card-shaped storage media can be attached. Further, the shapes of the card-shaped storage media are not limited to those described in the embodiment. The shapes of the card-shaped storage media allowed to be attached into the mount portion may be equal to each other.

The information processing apparatus is not limited to a portable computer. For example, the information processing apparatus may be provided as another apparatus such as a digital camera or a PDA (Personal Digital Assistant).

What is claimed is:

1. A card connection device comprising:
a device body;
a mount portion being provided in an inside of the device body, the mount portion having a plurality of regions into which a plurality of card-shaped storage media can be detachably attached, and the a plurality of regions being piled up on one another in a direction of thickness of the card-shaped storage media;
a slot being provided in the device body, the slot having a opening shape corresponding to the plurality of regions so as to insert the card-shaped storage media into the regions respectively; and
a stopper being provided in the mount portion of the device body, the stopper being displaced in the direction of the card-shaped storage medium by a contact with the one card-shaped storage medium so as to prevent the other card-shaped storage medium from being inserted into remaining regions, when one of the card-shaped storage medium is inserted into corresponding one of the plurality of regions through the slot.

2. A card connection device according to claim 1, wherein the plurality of card-shaped storage media are different from one another in width,
wherein the plurality of regions of the mount portion are different from one another in width, so that the plurality of regions correspond to the plurality of card-shaped storage media respectively.

3. A card connection device according to claim 2, wherein the slot has a plurality of opening portions corresponding to the plurality of regions, and
wherein the plurality of opening portions are different from one another in width while the opening portions communicate with one another along a direction of buildup of the plurality of regions.

4. A card connection device according to claim 1, wherein the mount portion has a first end portion and a second end portion which are separate from each other in a direction of width of the card-shaped storage media, and
wherein the stopper is provided in the first and second end portions of the mount portion, respectively.

5. A card connection device according to claim 1, wherein the stopper has a plurality of cam faces with which the card-shaped storage media come into contact, and
wherein the stopper is displaced in the direction of thickness of the card-shaped storage media in accordance with shapes of the cam faces.

6. A card connection device according to claim 5, wherein when the card-shaped storage medium is removed from the plurality of regions, the stopper is retained in a neutral position where the cam faces of the stopper are exposed to the plurality of regions.

7. A card connection device according to claim 1, wherein adjacent regions of the plurality of regions in the mount portion are arranged to at least partially overlap in the direction of thickness of the card-shaped storage media.

8. A card connection device according to claim 1, wherein the device body is put in a housing of an information processing apparatus in a condition that the housing has a controller for executing reading/writing of data from/into one of card-shaped storage media attached into the mount portion.

9. An information processing apparatus comprising:
a housing; and
a card connection device being provided in the housing, the card connection device detachably attaching a plurality of card-shaped storage media, wherein
the card connection device includes:
a mount portion being provided in an inside of the device body, the mount portion having a plurality of regions into which a plurality of card-shaped storage media can be detachably attached, and the plurality of regions being piled up on one another in a direction of thickness of the card-shaped storage media;
a slot being provided in the device body, the slot having an opening shape corresponding to the plurality of regions so as to insert the card-shaped storage media into the regions respectively; and
a stopper being provided in the mount portion of the device body, the stopper being displaced in the direction of the card-shaped storage medium by a contact with the one card-shaped storage medium so as to prevent the other card-shaped storage medium from being inserted into remaining regions, when one of the card-shaped storage medium is inserted into corresponding one of the plurality of regions through the slot, and
wherein the housing has a controller for executing reading/writing of data from/into one kind of card-shaped storage medium attached into the mount portion.

10. An information processing apparatus according to claim 9, wherein the plurality of regions of the mount portion are piled up on one another in a direction of thickness of the housing, and
wherein adjacent regions in the mount portion are arranged to at least partially overlap one another in the direction of thickness of the housing.

11. An information processing apparatus according to claim 10, wherein the stopper has a plurality of cam faces with which the card-shaped storage media come into contact, and
wherein the stopper is displaced in the direction of thickness of the card-shaped storage media in accordance with shapes of the cam faces.
